(19) United States
(12) Patent Application Publication
(10) Pub. No.: US 2012/0323900 A1
(43) Pub. Date: Dec. 20, 2012

(54) METHOD FOR PROCESSING AUXILARY INFORMATION FOR TOPIC GENERATION

(76) Inventors: Bankim A. Patel, Hillsborough, NJ (US); Ashwin Kashyap, Mountain View, CA (US); Avinash Sridhar, Cranbury, NJ (US); Saurabh Mathur, Monmouth Junction, NJ (US); Dekai Li, Lawrenceville, GA (US)

(21) Appl. No.: 13/577,970

(22) PCT Filed: Feb. 23, 2011
(86) PCT No.: PCT/US2011/000328

§ 371 Date: Aug. 9, 2012

Related U.S. Application Data
(60) Provisional application No. 61/307,393, filed on Feb. 23, 2010.

(51) Int. Cl. G06F 17/30

(52) U.S. Cl. 707/723; 707/769; 707/722; 707/E17.014

(57) ABSTRACT

Analyzing auxiliary information associated with a video asset is performed. A topic is then determined from the extracted keywords where the topic is used as a basis of a query to return results such as news articles and other related information that is relevant to the topic of a video asset current being viewed or accessed. These steps are repeated when a topic changes

### CROSS-REFERENCE TO RELATED APPLICATIONS

This application claims priority from U.S. Provisional Application Ser. No. 61/307,393 filed Feb. 23, 2010, which is incorporated by reference herein in its entirety.

### FIELD OF THE INVENTION

The field of the invention is related towards supplementing media with additional information such as metadata, more specifically this invention relates to the processing of metadata that accompanies a media asset.

### BACKGROUND OF THE INVENTION

When a user consumes media by using a consuming device such as a television, computer, mobile device, set top box, and the like, the user typically will be watching a video media asset such as a movie, television show, short streamed video, and the like. Such video programming usually is accompanied with an audio information and information which describes the audio information. For example, a television program in the United States is transmitted with closed caption information which displays as text the spoken words that are part of the audio information. Other types of auxiliary information such as teletext information, Uniform Resource Locators which point to internet related websites/media, and the like can be transmitted with the video programming, as well.

A user consuming a video asset can attempt to find more media that is related to asset currently being consumed. To do this, a user can access the program guide information that accompanies that video asset and attempt to reference such information against other program guide information for video programming. The problem with this approach however is that program guide information provides a “macro” view of view programming where only generalized information can be gleaned.

An approach to attempt to get more significant information about a video program consists of a user or a device applying a technique that will access closed captioning information that accompanies the video. For example, Google has a query-free news search feature that will access the closed captioning information of a video asset and extract keyword terms that can be further processed in a search engine. The use of keywords alone is a problem because the closed captioning information can have different words (money, stock, market) refer to the same thing (finance) and a search engine or other processing scheme can have difficult ranking between such terms.

### SUMMARY OF THE INVENTION

A method for analyzing the auxiliary information associated with a video asset. A topic is then determined from the extracted keywords where the topic is used as a basis of a query to return results such as news articles and other related information that is relevant to the topic of a video asset current being viewed. The method also detects when the topic changes.

### DETAIL DESCRIPTION OF THE DRAWINGS

These and other aspects, features and advantages of the present disclosure will be described or become apparent from the following detailed description of the preferred embodiments, which is to be read in connection with the accompanying drawings.

In the drawings, wherein like reference numerals denote similar elements throughout the views:

FIG. 1 shows a block diagram of an embodiment of a system for delivering content to a home or end user.

FIG. 2 presents a block diagram of a system that presents an arrangement of media servers, online social networks, and consuming devices for consuming media.

FIG. 3 shows a block diagram of an embodiment of a set top box/digital video recorder;

FIG. 4 shows a method chart for flowchart for determining if topics changed for a video asset;

FIG. 5 shows a block diagram of a configuration for receiving multiple broadcast feeds for topic extraction; and

FIG. 6 is an embodiment of the display of returned results as news stories with a video broadcast.

### DETAILED DESCRIPTION OF THE INVENTION

It should be understood that the elements shown in the figures can be implemented in various forms of hardware, software or combinations thereof. Preferably, these elements are implemented in a combination of hardware and software on one or more appropriately programmed general-purpose devices, which can include a processor, memory and input/output interfaces. Herein, the phrase “coupled” is defined to mean directly connected to or indirectly connected with through one or more intermediate components or signal paths. Such intermediate components can include both hardware and software based components.

The present description illustrates the principles of the present disclosure. It will thus be appreciated that those skilled in the art will be able to devise various arrangements that, although not explicitly described or shown herein, embody the principles of the disclosure and are included within its scope.

All examples and conditional language recited herein are intended for pedagogical purposes to aid the reader in understanding the principles of the disclosure and the concepts contributed by the inventor to furthering the art, and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that the block diagrams presented herein represent conceptual views of illustrative circuitry embodying the principles of the disclosure. Similarly, it will be appreciated that any flow charts, flow diagrams, state transition diagrams, pseudocode, and the like represent various processes that can be substantially represented in computer readable media and so executed by a computer or processor, whether or not such computer or processor is explicitly shown. The computer readable media and code written on can be implemented in a transitory state (signal) and a non-transitory state (e.g., on a tangible medium such as CD-ROM, DVD, Blu-Ray, Hard Drive, flash card, or other type of tangible storage medium).

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read only memory (“ROM”) for storing software, random access memory (“RAM”), and nonvolatile storage.

Other hardware, conventional and/or custom, can also be included. Similarly, any switches shown in the figures are conceptual only. Their function can be carried out through the operation of program logic, through dedicated logic, through the interaction of program control and dedicated logic, or even manually, the particular technique being selectable by the implementer as more specifically understood from the context.

In the claims hereof, any element expressed as a means for performing a specified function is intended to encompass any way of performing that function including, for example, a) a combination of circuit elements that performs that function or b) software in any form, including, therefore, firmware, microcode or the like, combined with appropriate circuitry for executing that software to perform the function. The disclosure as defined by such claims resides in the fact that the functionalities provided by the various recited means are combined and brought together in the manner which the claims call for. It is thus regarded that any means that can provide those functionalities are equivalent to those shown herein.

In the description, the presence of metadata in the form of auxiliary information is expected to accompany a video asset, as an example of a media asset. A media asset can be video, audio, a mixture of both, and the like. Metadata as auxiliary information can be teletext, closed captioning information, text, uniform resource locators that point to additional media, triggers, and the like. In most of the embodiments described below, the auxiliary information described will be closed captioning information, even though other types of auxiliary information can be processed using the described principles as well.

One video asset that presents a challenge is a news program. During a news broadcast, many different types of topics are presented (such as politics, sports, weather, local interest, national news, trivia, and the like). The principles of the invention are described in connection with a news program (because of the dynamic nature of how the topics within the same video asset can change. This description is not limiting in that other video assets such as movies, dramas, comedies, YouTube videos, and the like can have the described principles applied to such assets as well.

Systems for delivering various types of content to a user and the processing of such content will be described.

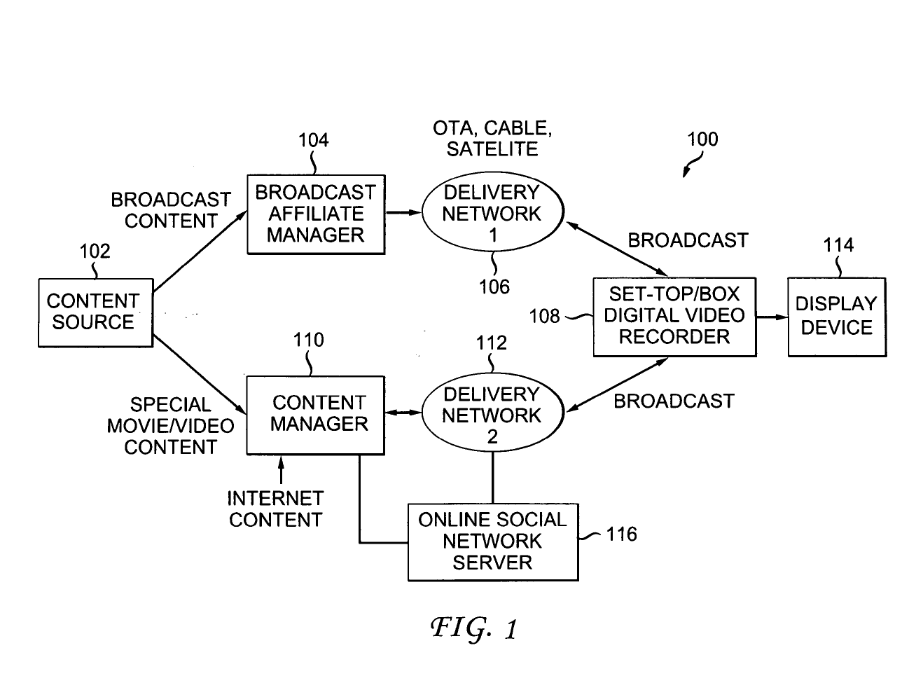

With reference to FIG. 1, a block diagram of an embodiment of a system 100 for delivering content to a home or end user is shown. The content originates from a content source 102, such as a movie studio or production house. The content can be supplied in at least one of two forms. One form can be a broadcast form of content. The broadcast content is provided to the broadcast affiliate manager 104, which is typically a national broadcast service, such as the American Broadcasting Company (ABC), National Broadcasting Company (NBC), Columbia Broadcasting System (CBS), etc. The broadcast affiliate manager can collect and store the content, and can schedule delivery of the content over a deliver network, shown as delivery network 1 (106). Delivery network 1 (106) can include satellite link transmission from a national center to one or more regional or local centers. Delivery network 1 (106) can also include local content delivery using local delivery systems such as over the air broadcast, satellite broadcast, cable broadcast or from an external network via IP. The locally delivered content is provided to a user's set top box/digital video recorder (DVR) 108 in a user's home, where the content will subsequently be included in the body of available content that can be searched by the user.

A second form of content is referred to as special content. Special content can include content delivered as premium viewing, pay-per-view, or other content not otherwise provided to the broadcast affiliate manager. In many cases, the special content can be content requested by the user. The special content can be delivered to a content manager 110. The content manager 110 can be a service provider, such as an Internet website, affiliated, for instance, with a content provider, broadcast service, or delivery network service. The content manager 110 can also incorporate Internet content into the delivery system, or explicitly into the search only such that content can be searched that has not yet been delivered to the user's set top box/digital video recorder 108. The content manager 110 can deliver the content to the user's set top box/digital video recorder 108 over a separate delivery network, delivery network 2 (112). Delivery network 2 (112) can include high-speed broadband Internet type communications systems. It is important to note that the content from the broadcast affiliate manager 104 can also be delivered using all or parts of delivery network 2 (112) and content from the content manager 110 can be delivered using all or parts of Delivery network 1 (106). In addition, the user can also obtain content directly from the Internet via delivery network 2 (112) without necessarily having the content managed by the content manager 110. In addition, the scope of the search goes beyond available content to content that can be broadcast or made available in the future.

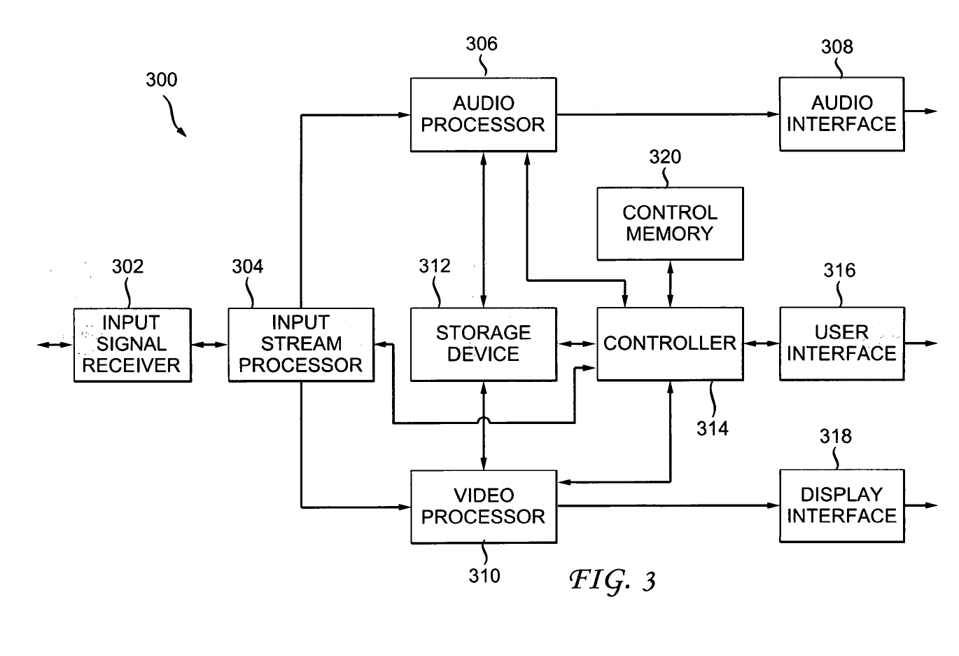

The set top box/digital video recorder 108 can receive different types of content from one or both of delivery network 1 and delivery network 2. The set top box/digital video recorder 108 processes the content, and provides a separation of the content based on user preferences and commands. The set top box/digital video recorder can also include a storage device, such as a hard drive or optical disk drive, for recording and playing back audio and video content. Further details of the operation of the set top box/digital video recorder 108 and features associated with playing back stored content will be described below in relation to FIG. 3. The processed content is provided to a display device 114. The display device 114 can be a conventional 2-D type display or can alternatively be an advanced 3-D display. It should be appreciated that other devices having display capabilities such as wireless phones, PDAs, computers, gaming platforms, remote controls, multi-media players, or the like, can employ the teachings of the present disclosure and are considered within the scope of the present disclosure.

Delivery network 2 is coupled to an online social network 116 which represents a website or server in which provides a social networking function. For instance, a user operating set top box 108 can access the online social network 116 to access electronic messages from other users, check into recommendations made by other users for content choices, see pictures posted by other users, refer to other websites that are available through the “Internet Content” path.

Online social network server 116 can also be connected with content manager 110 where information can be exchanged between both elements. Media that is selected for viewing on set top box 108 via content manager 110 can be referred to in an electronic message for online social networking 116 from this connection. This message can be posted to the status information of the consuming user who is viewing the media on set top box 108. That is, a user using set top box 108 can instruct that a command be issued from content manager 110 that indicates information such as the <<ASSETID>>, <<ASSETTYPE>>, and <<LOCATION>> of a particular media asset which can be in a message to online social networking server 116 listed in <<SERVICE ID>> for a particular user identified by a particular field <<USERNAME>> is used to identify a user. The identifier can be an e-mail address, hash, alphanumeric sequence, and the like . . . .

Content manager 110 sends this information to the indicated social networking server 116 listed in the <<SERVICE ID>>, where an electronic message for &USERNAME has the information comporting to the <<ASSETID>>, <<ASSETTYPE>>, and <<LOCATION>> of the media asset posted to status information of the user. Other users who can access the social networking server 116 can read the status information of the consuming user to see what media the consuming user has viewed.

Examples of the information of such fields are described below.

TABLE 1

| | |
|---|---|
| <<SERVICE ID> | This field represents a particular social networking |
| | service or other messaging medium that can be used. |
| &FACEBOOK | Facebook |
| &TWITTER | Twitter |
| &LINKEDIN | Linked-In |
| &FLICKER | Flicker Photo Sharing |
| &QZONE | Q-Zone |
| &MYSPACE | MySpace |
| &BEBO | Bebo |
| &SMS | Text Messaging Service |
| &USERNAME | User Name of a person using a social networking |
| | service |

TABLE 2

| | |
|---|---|
| <<ASSETID>> | This field represents the “name” of the |
| | media asset which is used for identifying the |
| | particular asset |
| &UUID | A universal unique identifier that is used for the |
| | media asset. This can be a unique MD5, SHA1, |
| | other type of hash, or other type of identifier |
| &NAME | A text name for the media asset |
| &TIME | Time that a media asset is being accessed. This |
| | information can be seconds, hours, days, day of |
| | the week, date, and other time related information |
| &ASSETCOMPLETE | The % of completion in the consumption of an |
| | asset |

The term media asset (as described below for TABLE 3) can be: a video based media, an audio based media, a television show, a movie, an interactive service, a video game, a HTML based web page, a video on demand, an audio/video broadcast, a radio program, advertisement, a podcast, and the like.

TABLE 3

| | |
|---|---|
| <<ASSETTYPE> | This field represents the type of asset |
| | that is being communicated to a user of |
| | a social networking website. |
| &VIDEO | Video based asset |
| &AUDIO | Audio based asset |
| &PHOTO | Photo based asset |
| &TELEVISION | Television show asset which can be audio, video, |
| | or a combination of both |
| &MOVIE | Movie asset which can be audio, video, |
| | or a combination of both |
| &HTML | HTML based web page |
| &PREVIEW | Trailer which can be audio, video, |
| | or a combination of both |
| &ADMOVE | Advertisement asset—expected to be video and/or |
| | audio based such as a flash animation, H.264 video, |
| | SVC video, and the like. |
| &ADSTAT | Advertisement asset—expected to be a static image |
| | such as a JPG, PNG, and the like that can be used |
| | as a banner ad |
| &TEXT | Text Message |
| &RADIO | An audio asset that comes from terrestrial |
| | and/or satellite radio |
| &GAME | Game asset. |
| &INTERACTIVE | An interactive based media asset |
| &PODCAST | Podcast that is audio, video, or a combination of both |
| &APPLICATION | Indicates that a user utilized a particular type of |
| | application or accessed a particular service |

TABLE 4

| | |
|---|---|
| <<LOCATION> | This field represents the location of a particular media asset |
| &URL | The location of a media asset expressed as a uniform resource |
| | locator and/or IP address |
| &PATH\PATH... | The location of a media asset expressed as a particular local or |
| | remote path which can have multiple subdirectories. |
| &REMOTE | The location of a media asset in a remote location which would be |
| | specified by text after the remote attribute. |
| &LOCAL | The location of a media asset in a local location which would be |
| | specified by text after the remote attribute. |
| &BROADCAST | The location being a broadcast source such as satellite, broadcast |
| | television channel, cable channel, radio station, and the like |
| &BROADCASTID | The identifier of the broadcast channel used for transmitting a media |
| | asset, and the like |
| &SERVICE | Identification of a service for which a media asset can originate (as |
| | a content source or content provider). Examples of different |
| | services include HULU, NETFLIX, VUDU, and the like. |

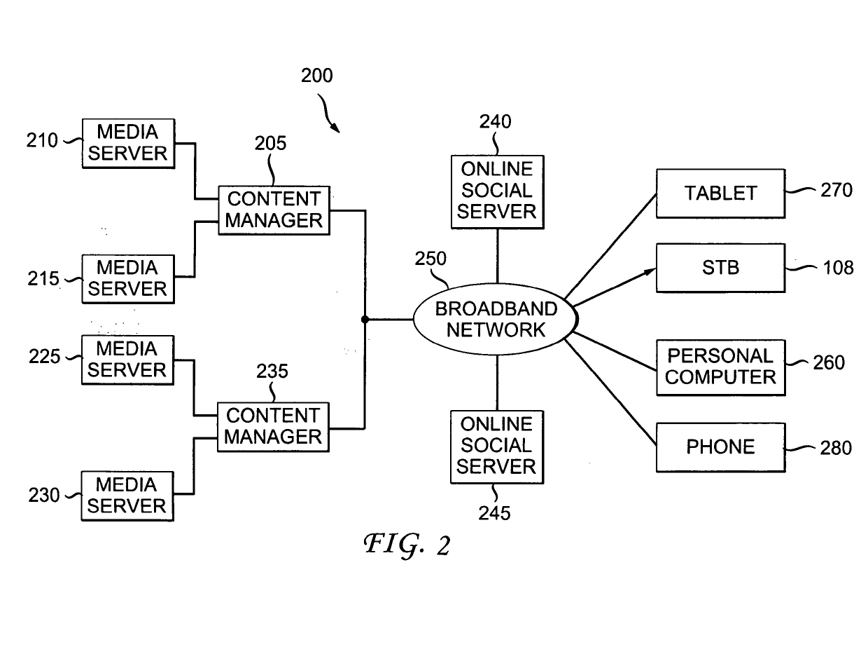

FIG. 2 presents a block diagram of a system 200 that presents an arrangement of media servers, online social networks, and consuming devices for consuming media. Media servers 210, 215, 225, and 230 represent media servers where media is stored. Such media servers can be a hard drive, a plurality of hard drives, a server farm, a disc based storage device, and other type of mass storage device that is used for the delivery of media over a broadband network.

Media servers 210 and 215 are controlled by content manager 205. Likewise, media server 225 and 230 are controlled by content manager 235. In order to access the content on a media server, a user operating a consumption device such as STB 108, personal computer 260, table 270, and phone 280 can have a paid subscription for such content. The subscription can be managed through an arrangement with the content manager 235. For example, content manager 235 can be a service provider and a user who operates STB 108 has a subscription to programming from a movie channel and to a music subscription service where music can be transmitted to the user over broadband network 250. Content manager 235 manages the storage and delivery of the content that is delivered to STB 108. Likewise, other subscriptions can exist for other devices such as personal computer 260, tablet 270, and phone 280, and the like. It is noted that the subscriptions available through content manager 205 and 235 can overlap, where for example; the content comporting for a particular movie studio such as DISNEY can be available through both content managers. Likewise, both content managers 205 and 235 can have differences in available content, as well, for example content manager 205 can have sports programming from ESPN while content manager 235 makes available content that is from FOXSPORTS. Content managers 205 and 235 can also be content providers such as NETFLIX, HULU, and the like who provide media assets where a user subscribes to such a content provider. An alternative name for such types of content providers is the term over the top service provider (OTT) which can be delivered “on top of” another service. For example, considering FIG. 1 content manager 110 provides internet access to a user operating set top box 108. An over the top service from content manager 205/235 (as in FIG. 2) can be delivered through the “internet content” connection, from content source 102, and the like.

By a content manager 205, 235, a subscription is not the only way that content can be authorized. Some content can be accessed freely through a content manager 205, 235 where the content manager does not charge any money for content to be accessed. Content manager 205, 235 can also charge for other content that is delivered as a video on demand for a single fee for a fixed period of viewing (# of hours). Content can be bought and stored to a user's device such as STB 108, personal computer 260, tablet 270, and the like where the content is received from content managers 205, 235. Other purchase, rental, and subscription options for content managers 205, 235 can be utilized as well.

Online social servers 240, 245 represent the servers running online social networks that communicate through broadband network 250. Users operating a consuming device such as STB 108, personal computer 260, tablet 270, and phone 280 can interact with the online social servers 240, 245 through the device, and with other users. One feature about a social network that can be implemented is that users using different types of devices (PCs, phones, tablets, STBs) can communicate with each other through a social network. For example, a first user can post messages to the account of a second user with both users using the same social network, even though the first user is using a phone 280 while a second user is using a personal computer 260. Broadband network 250, personal computer 260, tablet 270, and phone 280 are terms that are known in the art. For example, a phone 280 can be a mobile device that has Internet capability and the ability to engage in voice communications.

Turning now to FIG. 3, a block diagram of an embodiment of the core of a set top box/digital video recorder 300 is shown, as an example of a consuming device. The device 300 shown can also be incorporated into other systems including the display device 114. In either case, several components necessary for complete operation of the system are not shown in the interest of conciseness, as they are well known to those skilled in the art.

In the device 300 shown in FIG. 3, the content is received in an input signal receiver 302. The input signal receiver 302 can be one of several known receiver circuits used for receiving, demodulation, and decoding signals provided over one of the several possible networks including over the air, cable, satellite, Ethernet, fiber and phone line networks. The desired input signal can be selected and retrieved in the input signal receiver 302 based on user input provided through a control interface (not shown). The decoded output signal is provided to an input stream processor 304. The input stream processor 304 performs the final signal selection and processing, and includes separation of video content from audio content for the content stream. The audio content is provided to an audio processor 306 for conversion from the received format, such as compressed digital signal, to an analog waveform signal. The analog waveform signal is provided to an audio interface 308 and further to the display device 114 or an audio amplifier (not shown). Alternatively, the audio interface 308 can provide a digital signal to an audio output device or display device using a High-Definition Multimedia Interface (HDMI) cable or alternate audio interface such as via a Sony/Philips Digital Interconnect Format (SPDIF). The audio processor 306 also performs any necessary conversion for the storage of the audio signals.

The video output from the input stream processor 304 is provided to a video processor 310. The video signal can be one of several formats. The video processor 310 provides, as necessary a conversion of the video content, based on the input signal format. The video processor 310 also performs any necessary conversion for the storage of the video signals.

A storage device 312 stores audio and video content received at the input. The storage device 312 allows later retrieval and playback of the content under the control of a controller 314 and also based on commands, e.g., navigation instructions such as fast-forward (FF) and rewind (Rew), received from a user interface 316. The storage device 312 can be a hard disk drive, one or more large capacity integrated electronic memories, such as static random access memory, or dynamic random access memory, or can be an interchangeable optical disk storage system such as a compact disk drive or digital video disk drive. In one embodiment, the storage device 312 can be external and not be present in the system.

The converted video signal, from the video processor 310, either originating from the input or from the storage device 312, is provided to the display interface 318. The display interface 318 further provides the display signal to a display device of the type described above. The display interface 318 can be an analog signal interface such as red-green-blue (RGB) or can be a digital interface such as high definition multimedia interface (HDMI). It is to be appreciated that the display interface 318 will generate the various screens for presenting the search results in a three dimensional array as will be described in more detail below.

The controller 314 is interconnected via a bus to several of the components of the device 300, including the input stream processor 302, audio processor 306, video processor 310, storage device 312, and a user interface 316. The controller 314 manages the conversion process for converting the input stream signal into a signal for storage on the storage device or for display. The controller 314 also manages the retrieval and playback of stored content. Furthermore, as will be described below, the controller 314 performs searching of content, either stored or to be delivered via the delivery networks described above. The controller 314 is further coupled to control memory 320 (e.g., volatile or non-volatile memory, including random access memory, static RAM, dynamic RAM, read only memory, programmable ROM, flash memory, EPROM, EEPROM, etc.) for storing information and instruction code for controller 214. Further, the implementation of the memory can include several possible embodiments, such as a single memory device or, alternatively, more than one memory circuit connected together to form a shared or common memory. Still further, the memory can be included with other circuitry, such as portions of bus communications circuitry, in a larger circuit.

To operate effectively, the user interface 316 of the present disclosure employs an input device that moves a cursor around the display, which in turn causes the content to enlarge as the cursor passes over it. In one embodiment, the input device is a remote controller, with a form of motion detection, such as a gyroscope or accelerometer, which allows the user to move a cursor freely about a screen or display. In another embodiment, the input device is controllers in the form of touch pad or touch sensitive device that will track the user's movement on the pad, on the screen. In another embodiment, the input device could be a traditional remote control with direction buttons.

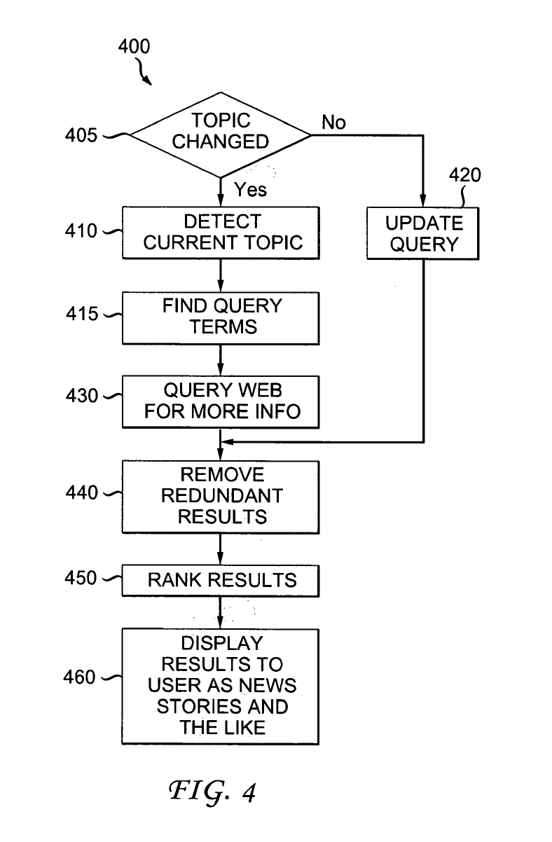

FIG. 4 describes a method 400 for obtaining topics that are associated with a media asset. Although the method begins with a step 405 of extracting keywords from auxiliary information associated with a media asset, this step is not the final processing for this method, unlike other keyword extraction techniques. One approach which can use a closed captioning processor (in a set top box 108, in a content manager 205/235, or the like) which reads in the EIA-608/EIA-708 formatted closed captioning information that is transmitted with a video media asset. The closed captioning processor can have a data slicer which outputs the captured closed caption data as an ASCII text stream.

It is noted for different broadcast sources will be arranged differently, where the closed captioning and other types of auxiliary information can be configured to extract the data of interest depending on the way how the data stream is configured. For example, an MPEG-2 transport stream that is formatted for broadcast in the United States using an ATSC format is different than the digital stream that is used for a DVB-T transmission in Europe, to an ARIB based transmission that is used in Japan.

In step 405, this step begins with the outputted text stream is processed in step to produce a series of keywords which are mapped to topics. That is, the outputted text stream is formatted into a series of sentences. Each sentence is processed to eliminate stop words where the remaining words are denoted as being keywords. The stop words are commonly used words that do not add to the semantic meaning of a sentence (e.g. of, on, is, an, the, etc.). Stop word lists for English language are well known. A pre-processing step, which can be part of step reads the stop words from such a list and removes them from the text stream.

The keywords are further processed in step 415 by mapping extracted keywords to a series of topics (as query terms) by using a predetermined thesaurus database that associates certain keywords with a particular topic. This database can be set up where a limited selection of topics are defined (such as particular people, subjects, and the like) and various keywords are associated with such topics by using a comparator that attempts to map a keyword against a particular subject. For example, thesaurus database (such as WordNet and the Yahoo OpenDirectory project) can be set up where the keywords such as money, stock, market, are associated with the topic “finance”. Likewise, keywords such as President of the United States, 44th President, President Obama, Barack Obama, are associated with the topic “Barack Obama”. Other topics can be determined from keywords using this or similar approaches for topic determination. Another method for doing this would be use Wikipedia (or similar) knowledge base where content is categorized based on topics. Given a keyword that has an associated topic in Wikipedia, a mapping of keyword to topics can be obtained for the purposes of creating as thesaurus database, as described above.

Once such topics are determined for each sentence, such sentences can be represented in the form of: <topic_{—}1:weight_{—}1;topic_{—}2;weight_{—}2, . . . , topic_n,weightN,ne_{—}1,ne_{—}2, . . . , ne_m>.

Topic_i is the topic that is identified based on the keywords in a sentence, weight_i is a corresponding relevance, Ne_i is the named entity that is recognized in the sentence. Named entities refer to people, places and other proper nouns in the sentence which can be recognized using grammar analysis.

It is possible that some entity is mentioned frequently but is indirectly referenced through the use of pronouns such as “he, she, they”. If each sentence is analyzed separately such pronouns will not be counted because such words are in the stop word list The word “you” is a special case as in that is used frequently. The use of name resolution will help assign the term “you” to a specific keyword/topic referenced in a previous/current sentence. Otherwise, “you” will be ignored if it can't be referenced to a specific term. To resolve this issue the name resolution can be done before the stop word removal.

If several sentences discuss the same set of topics and mention the same set of named entities, an assumption is made that the “current topic” of a series of sentences is currently being referenced. If a new topic is referenced over a new set of sentences, it is assumed that a new topic is being addressed. It is expected that topics will change frequently over the course of a video program.

These same principles can also be applied to receipt of a Really Simple Syndication (RSS) feed that is received by a user's device, which is typically “joined” by a user. These feeds typically represent text and related tags, where the keyword extraction process can be used to find relevant topics from the feed. The RSS feed can be analyzed to return relevant search results by using the approaches described below. Importantly, the use of both broadcast and RSS feeds can be done at the same time by using the approaches listed within this specification.

Topic Change Detection

When a current topic is over (405) and a new topic starts, such a change is detected by using a vector of keywords over a period of time. For example, in a news broadcast, many topics are discusses such as sports, politics, weather, etc. As mentioned previously, each sentence is represented as a list of topic weights (referred to as a vector). It is possible to compare the similarity of consecutive sentences (or alternatively between two windows containing a fixed number of words). There are many known similarity metrics to compare vectors, such as cosine similarity or using the Jaccard index. From the generation of such vectors, the terms can be compared and similarity is performed which notes the differences between such vectors. These comparisons are performed over a period of time. Such a comparison helps determine how much of change occurs from topic to topic, so that a predefined threshold can be determined where if the “difference” metric, depending on the technique used, exceeds the threshold, it is likely that the topic has changed.

As an example of this approach, a current sentence is checked against a current topic by using a dependency parser. Dependency parses process a given sentence and determines the grammatical structure of the sentence. These are highly sophisticated algorithms that employ machine learning techniques in order to accurately tag and process the given sentence. This is especially tricky for the English language due to many ambiguities inherent to the language. First, a check is performed to see if there are any pronouns in a sentence. If so, the entity resolution step is performed to determine which entities are mentioned in a current sentence. If no pronouns are used and if no new topics are found, it is assumed that the current sentence refers to the same topic as previous sentences. For example, if “he/she/they/his/her” is in a current sentence, it is likely that such terms refer to an entity from a previous sentence. It can be assumed that the use of such pronouns will have a current sentence refer to the same topic as a previous sentence. Likewise, for the following sentence, it can be assumed that the use of a pronoun in the sentence refers to the same topic as the previous sentence.

A change (405) between topics is noted when there is a change between the vectors of consecutive sentences, where the difference between two vectors varies by a significant difference. Such a difference can be changed in various embodiments, but it is noted that a large number (in a difference) can be more accurate in detecting a topic change, but using a large number imparts a longer delay of the detection of topics. A new query can be submitted with this new topic in step 420.

Related Information Retrieval

After detecting a current topic, more information can be determined for such a topic by using a search engine or news website where topics can be inputted to return news stores and websites in step 430. Specifically, the topics can be used to create a query term. Ideally, keywords such as proper nouns that are identified as people's names, organizations, locations, and the like (are given priority in the formation of a query. That is, these types of topics when entered into a search website such a GOOGLE or BING return better results than topics associated with common nouns.

A query can be fashioned in a format that is specific to the search engine being accessed when different search engines use different limiting criteria. For example, a query can be submitted that puts in criteria that specifies that the query results refer to a specific format (news stories, web pages, URLs, and the like), that the query results come from a specific source (e.g., news source such as Reuters/CNN, specific website, and the like), and other types of limitations.

The resulting query can be delivered in a format which can be parsed by the device that receives such results. For example, the results can be delivered in an XML format with various fields representing the head and the body of a news story which is returned as a “hit”. The results can also be returned as an RSS feed. As an optional, the results can also include website URLs that are returned in response to a submitted query. Other formats of how results can be returned can be implemented by those of the ordinary skill in the art. These are various forms of query results.

Another approach is to use both the most frequently named entity (proper noun) and the keyword that is most related to the topic during topic detection. Many search engines use keywords for searching, but using a topic alone may not be enough. Hence, the use of a topic and a frequently used keyword can provide specific results than by using a topic as the basis of a search, by itself. For example, determined topic “finance” may not provide any meaningful hits because of the reliance on an external search engine. If a query were offered with “finance” and a frequently used keyword associated with finance “money”, a search engine can provide better results especially when trying to return news stories.

The results of either approach described above are returned and ranked according to the relevance of a current topic in step 450. Such a ranking can be calculated by determining the amount of keywords that are shared between a video asset that is being analyzed and the news stories that are returned from a search engine (after a query is formulated). A covariance can be determined between the video asset and the text of such news story. The vector approach mentioned above can be used for performing such a comparison.

Redundancy Removal and Diversification

If a topic is very popular, many stories can be returned which are similar to each other. Therefore, the removal of redundant stories from returned search results is desirable (in step 440). One approach to eliminate such duplication is to apply a bag-of-word representation of each document and compare the amount of common words among multiple documents. If many words are common, it is determined that such documents are similar and one of them will be removed.

Another redundancy problem is related to the length of news stories. That is, it is desirable not to use news stories that are long and will take a long time to view. Likewise, it is desirable not to display search results for a long time as such results will appear to be stale. Hence, a threshold value update_duration is used when a topic does not change after a period of time denoted in this value, the detection of a new topic is performed or a new query is submitted. From the results of the new query, the news stories that were created the most recently will be displayed over other news articles (this can be done by analyzing time information with the article).

Alternatively, all of the topics over a period of time can be stored with the news stories that were previously matched. When the topic is repeated during this time period, other news stories are presented that matched but was not previously presented. This can be performed if the update_duration value exceeds a certain threshold for a particular topic. A second topic and its associated news stories can be presented during this time.

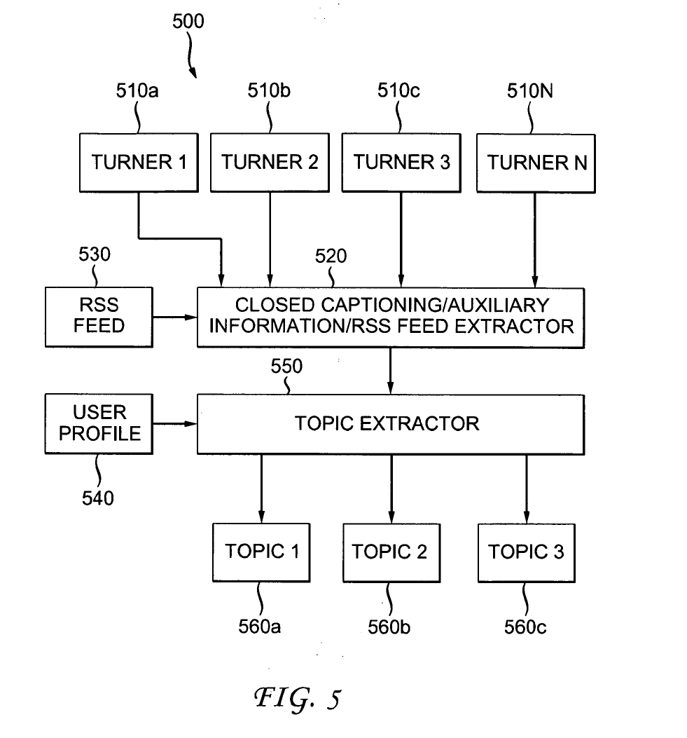

The principles above can be scaled in a manner consistent with FIG. 5 which shows a block diagram 500 of multiple tuners (510a, b, c . . . n) that receive a plurality of video content from different channels/sources (over the air broadcast, cable, satellite, IPTV, and the like). The auxiliary information associated with each of the tuners is processed in 520 by a closed captioning and RSS feed extractor to generate relevant keywords/metadata. The RSS feeds from 530 represent different sources of queries that can be parsed in a similar manner as a broadcast channel. This helps allow that idea of having both RSS feeds and video content be processed at the same time.

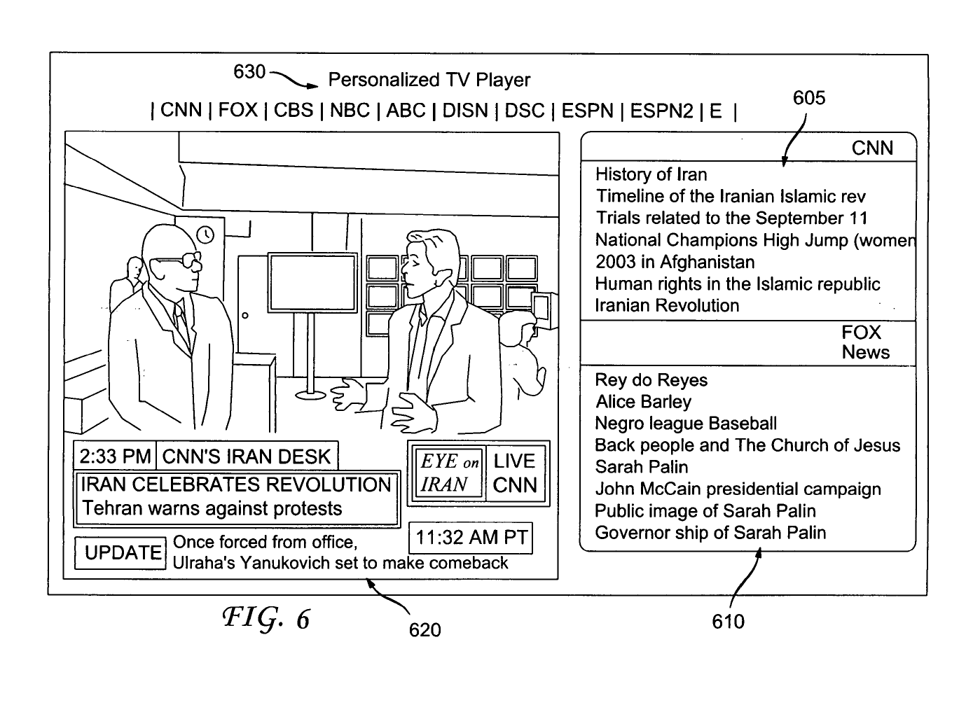

A user profile 540 affects how the topics can be selected and represented as in FIG. 6 (as shown for step 460). For example, a user can request that sources specific sources of information be used for presenting various news stories. For example, in FIG. 6, an interface is shown where both CNN (605) and FOX NEWS (610) have their news stories presented in response to the auxiliary information processed from the CNN analyzed video as shown in video frame 620. Additional sources of video channels can be selected by selecting the tabs at 630 (by selecting FOX, CBS, ABC, etc.), but the news sources (CNN, FOX NEWS) would stay the same unless the user profile was adjusted to select other sources (ESPN, GOOGLE NEWS, and the like).

User profile 540 can also be iteratively adjusted in response to the news stories that a user selects. That is, a preference engine can be used to select what search results are going to be more relevant (when represented) from the ones that are not likely to be used. For example, if a topic such as “SPORTS” is on the main screen, the user profile can indicate that news stories that focus on football be presented, over other sports. Likewise, the profile can reflect that a user would prefer sports scores over text about players who play specific sports. Other variations of how the user profile 540 can be adjusted can be performed in accordance with the principles described herein.

Topic extractor 550 is used for determining relevant topics from keywords, whereby the individual topics can be outputted in a manner as shown for 560a, 560b, 560c. These topics can then be submitted to a search engine for search results which can then be presented in a manner consistent with what is shown in FIG. 6.

1. A method for generating results related to a video asset currently being viewed comprising the steps of:
a. detecting at least one keyword associated with the auxiliary information of said video asset;
b. determining a topic from said at least one keyword;
c. returning at least one result from the basis of the topic being used as a query;
d. repeating steps a-c, as to determine if said topic has changed.

2. The method of claim 1 comprising an additional step of updating a query when said topic changes.

3. The method of claim 1, wherein said at least one result is a news story from a source which is specified in a user profile.

4. The method of claim 1, comprising the additional steps of determining a length of time a topic is associated with a video asset, and submitting a new query for a new topic when length of time exceeds a threshold value.

5. The method of claim 4, comprising the additional steps of storing information of a plurality of detected topics and selecting a topic from said plurality of topics when said length of time exceeds a threshold value, and said selected topic is different than said topic.

6. The method of claim 1 comprising the additional steps of processing an RSS feed to determine a topic associated with said RSS feed, and retuning results from a query generated from said topic associated with said RSS feed.

7. The method of claim 1 such that in the returning of said at least one result, redundant results are eliminated.

8. The method of claim 7 comprising the steps of ranking the at least one result and displaying at least one result without said redundant results.
